(19) United States
(12) Patent Application Publication
(10) Pub. No.: US 2009/0025494 A1
(43) Pub. Date: Jan. 29, 2009

(54) Vertically Movable Slide Unit for an Operating Machine, with an Integrate Anti-Fall Device

(75) Inventor: Michele Giusto, Grugliasco (Turin) (IT)

Correspondence Address: YOUNG & BASILE, P.C., 3001 WEST BIG BEAVER ROAD, SUITE 624, TROY, MI, 48084, US

(73) Assignee: Comau S.p.A., Grugliasco (Torino) (IT)

(21) Appl. No.: 12/136,442

(22) Filed: Jun. 10, 2008

(30) Foreign Application Priority Data
Jun. 27, 2007 (EP) 07425394.9

(51) Int. Cl. F16H 25/12

(52) U.S. Cl. 74/25

(57) ABSTRACT

A vertically movable slide unit for an operating machine includes a support structure, a slide slidably mounted along a vertical direction on the support structure and drive means of the vertical movement of the slide, carried by the support structure A safety device for preventing an accidental fall of the slide and operatively interposed between the slide and the support structure is foreseen, which is integrated within the slide.

### BACKGROUND OF THE INVENTION

The present invention relates to a vertically movable slide unit for an operating machine, of the type including a support structure, a slide slidably mounted along a vertical direction on the support structure, drive means of the vertical movement of the slide, carried by the support structure, and a safety device for preventing an accidental fall of the slide, operatively interposed between the slide and the support structure.

Vertical slide devices of the above type are used in a great variety of machines in the industry. A specific application of the present invention has been developed, for example by the Applicant, for an automatic assembly machine of the type which has formed the subject of the preceding European patent applications EP 06 425499 and EP 06 425500 of the Applicant (still secret at the filing date of this application). In machines of this type, the vertical slide is driven for example by an electric motor, through a screw and lead screw transmission, or still by a fluid actuator. In one case or the other, a safety main brake, directly associated to the motor or actuator, is foreseen for preventing an undesired movement of the slide, for example when operators have to carry out maintenance works in the operating area of the machine, below the movable structure carried by the vertical slide. In addition to such main brake, also an auxiliary anti-fall blocking device is foreseen, suitable for preventing any accidental falls of the structure carried by the slide.

### SUMMARY OF THE INVENTION

The object of the present invention is to carry out a device of this type which has an extremely simple, reliable and functional structure, which ensures a high safety degree against the accidental falls and which further has a reduced encumbrance and a simple maintenance.

In view of the obtainment of this aim, the object of the present invention is a device having all the features shown at the beginning of the present description and is further characterized in that the aforesaid anti-fall device is description and is further characterized in that the aforesaid anti-fall device is integrated within the slide.

In a preferred embodiment, the slide presents a body having a general plate-like conformation, with a front vertical face and a back vertical face. The support structure of the slide defines a guide vertical plane of the slide to which the back face of the slide is faced. According to the invention, the aforesaid anti-fall device is placed amongst opposite surfaces of the above guide plane carried by the support structure and the back vertical face of the slide.

Preferably, the anti-fall device includes a vertical rack and an engagement element of the rack, respectively carried by the fixed guide plane of the slide and the back face of the slide or, vice versa, by the back face of the slide and the guide plane of the slide.

In case of the aforesaid preferred embodiment, the guide plane of the slide defined by the support structure has a width corresponding with the width of the slide and the aforesaid anti-fall device is interposed amongst opposite side portions of the fixed guide plane and the back face of the slide. In such embodiment, the rack is carried by the guide plane and the engagement element of the rack is carried by the slide.

Always in case of the aforesaid preferred embodiment, the aforesaid slide guide plane includes a main portion, carrying guide means engaged by the slide, and a vertical side portion, protruding with respect to the main portion of the guide plane, on which said rack is arranged. The back face of the slide includes a main portion, carrying engagement means of the aforesaid guide means and a side vertical portion, protruding with respect to the main portion of the back face of the slide, on which the aforesaid engagement means is foreseen.

According to another feature, the aforesaid opposite side portions of the back face of the slide and the guide plane carried by the support structure are substantially situated in a same plane parallel to the guide plane of the slide and substantially passing through an action axis of said drive means of the slide movement.

Thanks to the above features, the device according to the invention presents evident advantages from the structure simplicity, operation reliability, reduced encumbrance and maintenance easiness points of view.

Still in case of the preferred embodiment of the invention, the engagement element of the rack is an element slidably mounted between an advanced engagement position of the rack and a down retracted position. Springy means, aiming to push such element towards its advanced position and actuator means for maintaining the engagement element within its retracted position against the action of the springy means are foreseen. During the normal functioning of the machine, actuator means are energized for maintaining the engagement element in the retracted condition, so as to exclude the functioning possibility of the anti-fall device. A sensor device is associated with the slide for detecting when the engagement element is in its retracted position and for signaling such condition to electronic control means, which allow the normal functioning of the machine only when the retracted position of the engagement element of the rack is confirmed.

In case of breakdown or need to carry out maintenance works in the operating area of the machine, actuators means are automatically deactivated, whereby the aforesaid springy means push the above mentioned engagement element in its advanced condition in engagement within the space between two adjacent tooth of the rack. In such condition, the slide is thus prevented from moving downwards with respect to the rack, whereby the maintenance works can be carried out with the required safety.

As it results apparent, all the anti-fall device is integrated within the slide structure, and does not present parts protruding outside the encumbrance of the slide, which allows the obtainment of a machine structure with a reduced encumbrance.

### BRIEF DESCRIPTION OF THE DRAWINGS

Further features and advantages of the invention will result apparent from the following description with reference to the enclosed drawings, given by mere way of not limiting example, in which:

FIG. 1 is diagrammatic perspective view of a part of an operating machine using a slide device according to the invention,

FIG. 2 shows the slide device of FIG. 1 in a different operating condition,

FIG. 3 is a perspective view corresponding with the one of FIG. 1, in which protection bellows associated with the slide have been removed, for a greater clearness of the illustration of the structure on which the slide is guided,

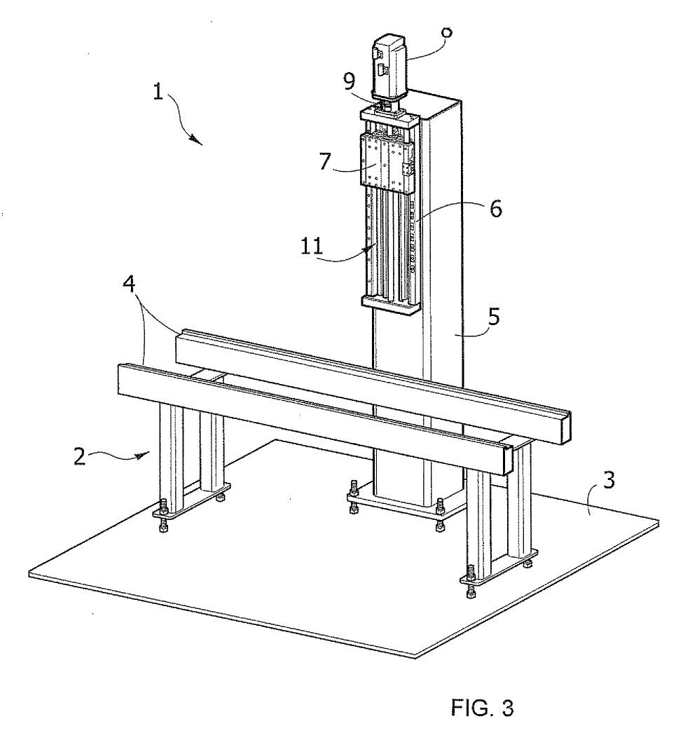

FIG. 4 is an enlarged scale perspective view of a particular of FIG. 3,

FIG. 5 is a further enlarged perspective view of a particular of FIG. 4,

FIG. 6 is an enlarged and partly sectioned scale view of the particular A of FIG. 5,

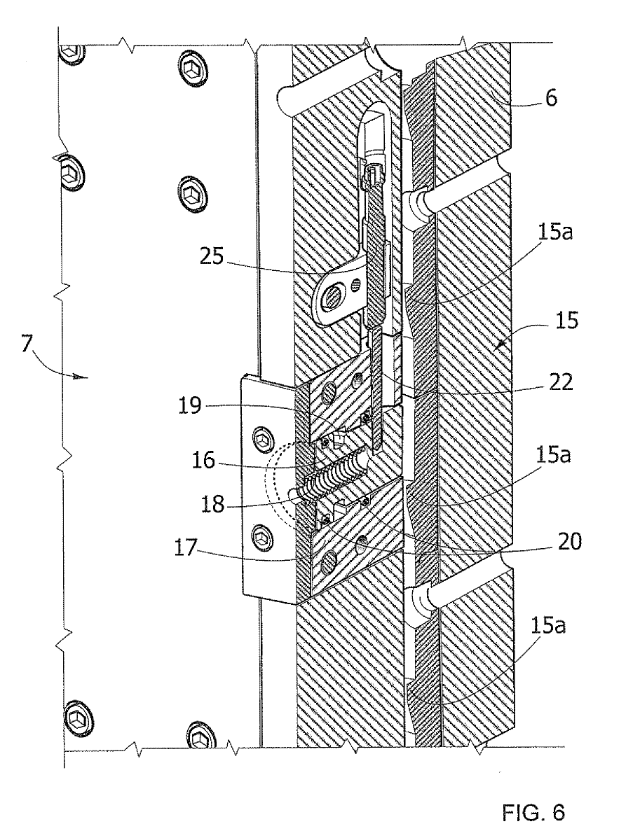

FIG. 7 is a sectional orthogonal view, according to the section plane visible in FIG. 6, which shows the anti-fall device in a first operating condition,

FIG. 8 shows the section of FIG. 7 in a different operating condition,

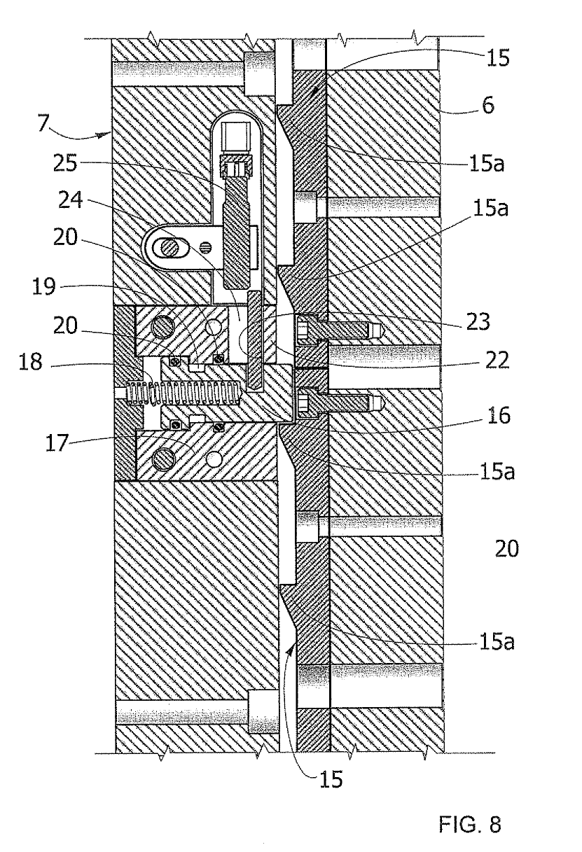

FIG. 9 is an additional partly perspective view of the slide with the relative anti-fall device,

FIG. 10 is a sectional perspective view, in an enlarged scale, of the particular A of FIG. 9, and

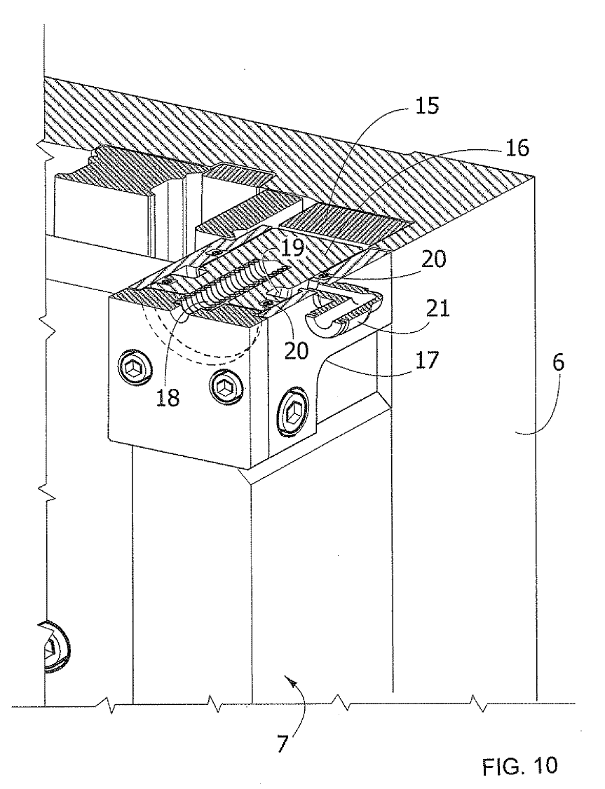

FIG. 11 is a sectional orthogonal view in the section plane of FIG. 10.

### DETAILED DESCRIPTION OF THE INVENTION

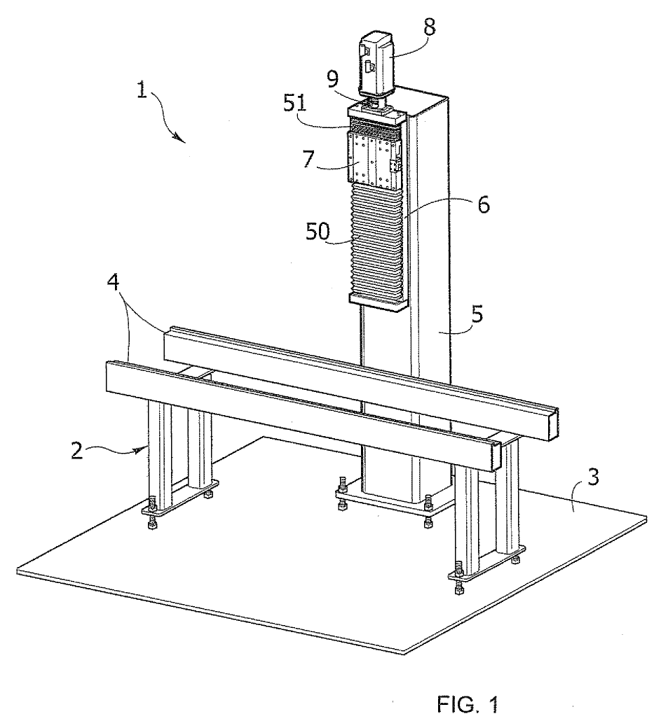

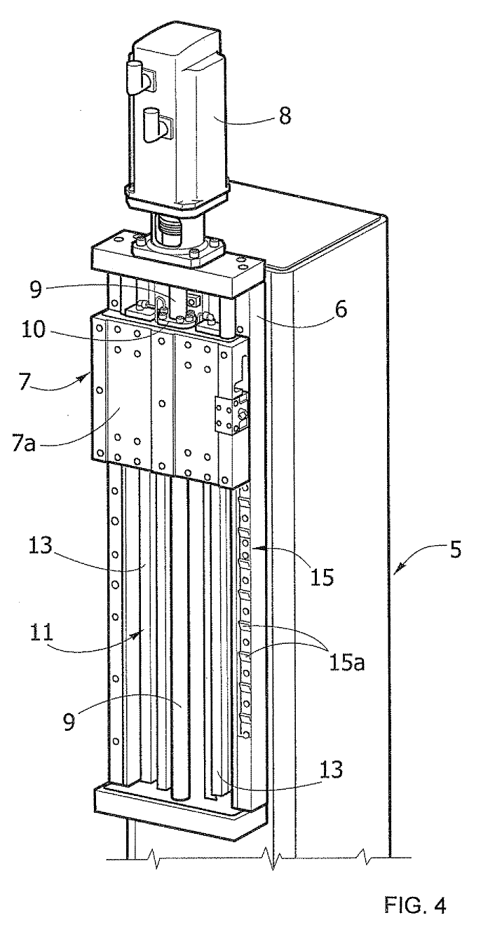

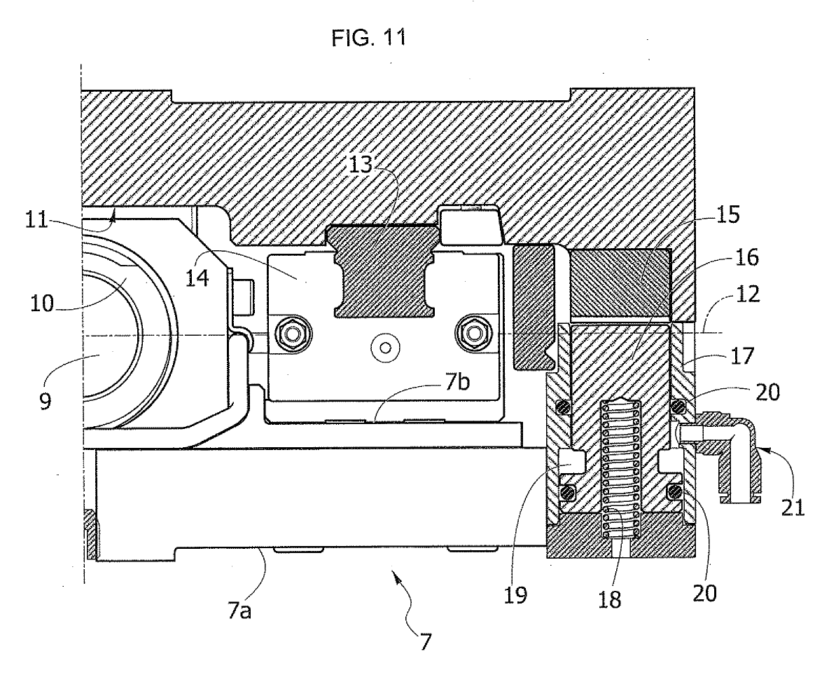

In FIG. 1, numeral 1 generally shows an operating machine of any type, for example an automated assembly machine, such as the one forming the subject of the preceding European patent application EP 06 425499 and 06 425500. In FIG. 1, many parts of the machine have been eliminated for clearness of illustration, while only some parts have been left, with reference to the application of the present invention. The machine includes a support structure 2 mounted on a floor 3 including, in the case of the example shown, horizontal profiles 4 intended for supporting a transport line for supplying the pieces on which the machine 1 have to operate until an operating zone of the machine. In correspondence of such zone, the machine includes a fixed vertical column 5 on which a supporting vertical structure 6 is mounted, on which a vertically sliding slide 7 is mounted. In the case of the example shown, the vertical movement of the slide 7 is driven by an electric motor 8 mounted on the top of the column 5, through a transmission including a screw 9 rotationally driven by the shaft of the motor 8 and a leadscrew 10 (see FIGS. 4 and 11) connected with the structure of the slide 9.

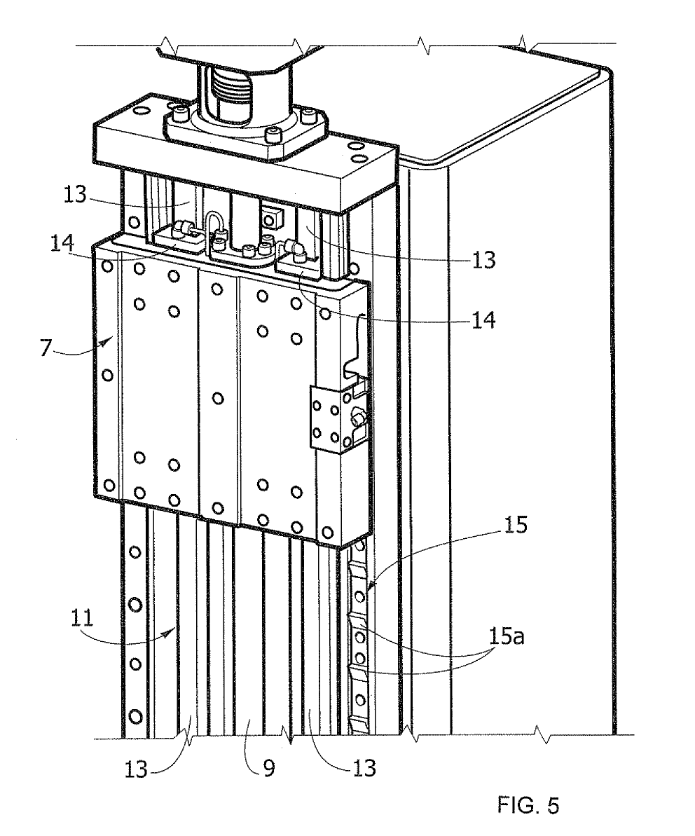

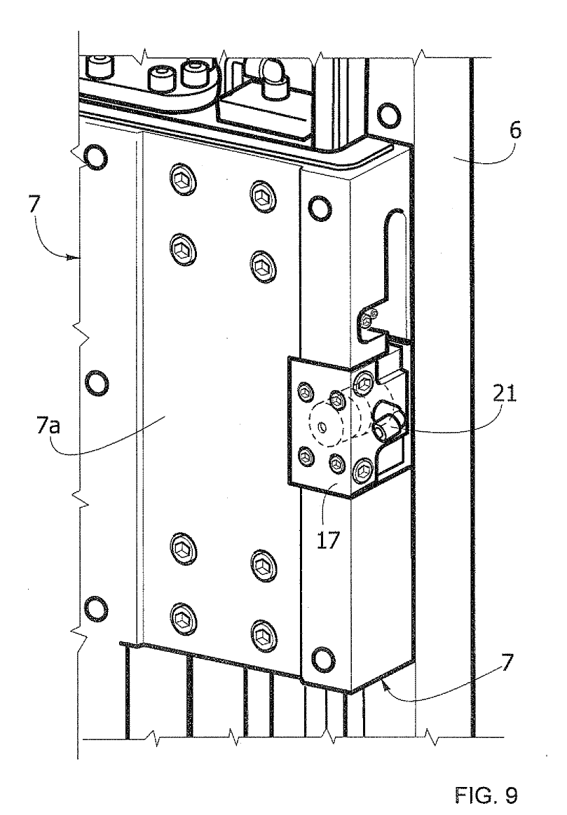

As it is clearly visible in FIG. 5, the slide 7 shows a general plate-like conformation, with a vertical front face 7a and a vertical back face 7b (see FIGS. 9, 11). As it is visible in FIG. 4 ad 11, the support structure 6 defines a guide vertical plane 11 of the slide 7, to which the back vertical face 7b of the slide 7 is faced. The slide 7 and the fixed structure 6 substantially show the same width.

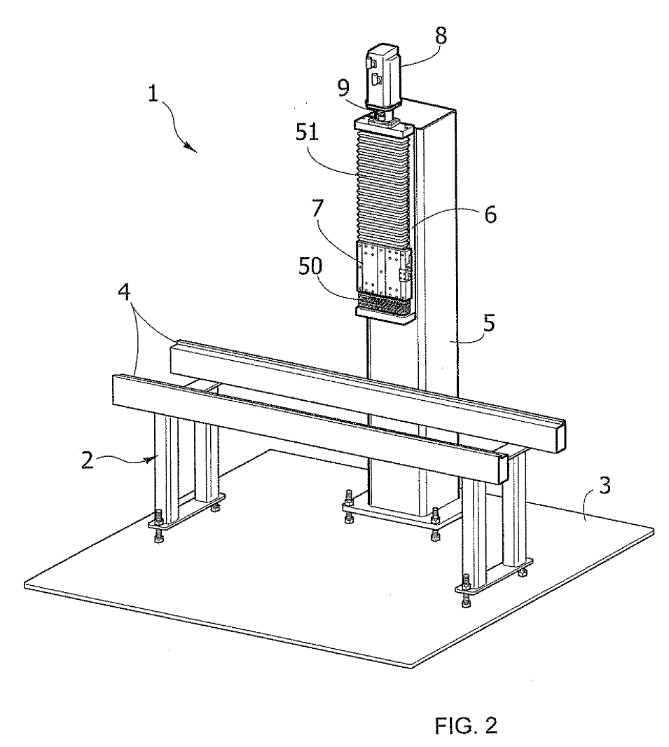

The plate-like body of the slide 7 shows two protruding side vertical portions with respect to the plane of the back face 7b, so as to define two back side surfaces (only one of which is visible in FIG. 11, which shows only half of the device) substantially contained in a same plane 12 spaced apart with respect to the plane of the back face 7b. Likewise, the support structure 6 shows its face faced towards the slide 7, defining the guide plane 11 of the slide, with a central portion and two vertical side portions, protruding with respect to the main portion and substantially contained in the plane 12. In this way, between the two central portions of the opposite surfaces of the support structure 6 and the slide 7 a space is defined, wherein (see FIG. 11) both the leadscrew 10, which is firmly connected with the slide 7 and is engaged by the screw 9, and two guide rails 13 fixed to the support structure 6, and two skids 14 firmly connected with the structure of the slide 7 and slidably engaged on the rails 13 are housed (see FIGS. 4, 11). FIGS. 1, 2 also show two bellows coverings 50, 51, interposed one between the lower end of the structure 6 and the lower end of the slide 7, and the other between the upper end of the structure 6 and the upper end of the slide 7, so as to cover the parts of the guide plane 11 defined by the fixed structure 6 above and below the slide.

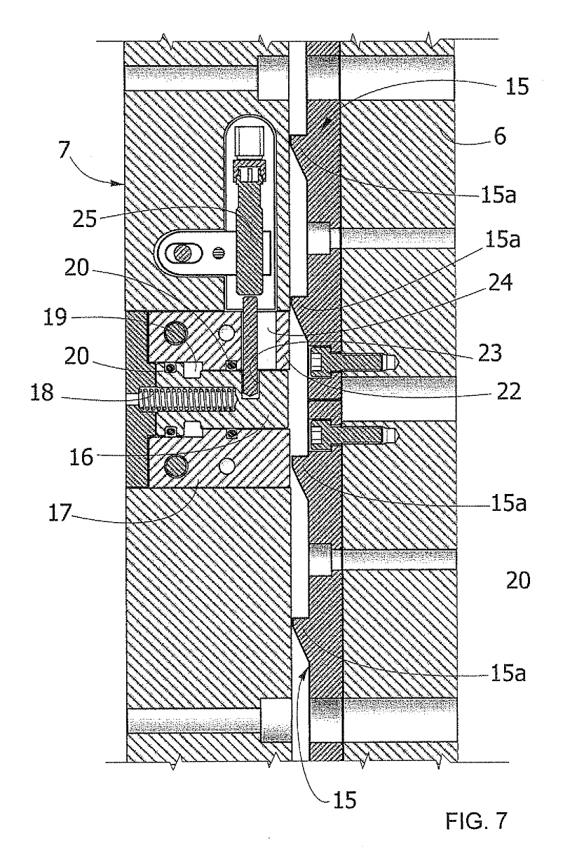

As it is visible in the drawings, along a side portion of the support structure 6 a vertical rack 15, having the profile visible in FIG. 7, is fixed, Such figure also shows the holes for the engagement of the fixing screws of the rack to the support structure 6. The rack 15 shows teeth 15a foreseen with a uniform pitch along the rack, each tooth 15a having a plane horizontal upper side and an inclined lower side. In a side portion of the body of the slide 7 which is opposite to the rack 15, an engagement element of the rack is arranged, which is shown by numeral 16. The element 16 shows a cylindrical body slidably mounted like a piston within a cylindrical cavity of a body 17 fixed to the slide 7. A coil spring 18 interposed between the sliding element 16 and the structure of the slide 7 tends to push the sliding element 16 in an advanced position in which it engages, with its front end, a space of the rack 15 faced to the same, so as to prevent a vertical movement of the slide relative to the support structure 6, unless for the short distance between two adjacent teeth of the rack 15. The body of the sliding element 16 defines an annular chamber 19 with the wall of the cylindrical cavity in which the element 16 is sliding, which is tightly isolated relative to the exterior through sealing rings 20.

The annular cavity 19 is supplied with pressurized air through a fitting 21 for maintaining the engagement element 16 in a retracted condition, not engaged by the rack 15 (see FIG. 7) against the action of the spring 18. In such a condition, the anti-fall device is deactivated. A pin 22 is forced in a cross seat 23 of the sliding element 16, so as to move with the sliding element 16, within an opening hole 24 obtained in the body 17. The pin 22 cooperates with a contact sensor 25 which sends an electric signal to an electronic control unit (not visible in the drawings) which shows if the engagement element 16 is in its retracted position or in its advanced position. Only in the first case, the electronic control unit allows the normal functioning of the machine.

The body of the slide 7 has a series of holes for the engagement of fixing screws of a structure intended for being carried by the slide and being vertically movable with the same.

The functioning of the machine above described is the following.

During the normal functioning of the machine, the engagement element 16 is in its retracted position, thanks to the activation of the compressed air feeding to the chamber 19 associated therewith. Such condition is detected by the sensor 25, which provides for sending a corresponding signal to the electronic control unit of the machine, so as to allow the normal functioning of the machines. In the case of any breakdown, the feeding of compressed air to the chamber 19 is automatically interrupted. Likewise, such feeding is voluntarily interrupted if one desires to carry out maintenance works in the operating zone of the machine. The deactivation of the compressed air feeding to the annular chamber 19 causes the displacement of the engagement element 16 in its engaged position on the rack 15, due to the spring 18. In such a condition, therefore, the device ensures that the slide 7 cannot displace downwards, with respect to the support structure, for a stroke higher than the pitch of the teeth of the rack 15. As it can be seen, such result is obtained without modifying the encumbrance of the body of the slide 7 since the anti-fall device is integrated within the slide and is obtained within the opposite side portions of the back face of the slide and the guide plane of the slide defined by the support structure.

Naturally, further without prejudice to the principle of the invention, construction details and embodiments could widely vary with respect to what has been described and shown by mere way of example, without leaving for this reason the ambit of the present invention.

What is claimed is:

1. Vertically movable slide unit for an operating machine, comprising:
a support structure,
a slide slidably mounted along a vertical direction on the support structure,
drive means for the vertical movement of the slide, carried by said support structure and
a safety device for preventing an accidental fall of the slide, operatively interposed between the slide and the support structure, wherein said anti-fall device is integrated within the slide.

2. Unit according to claim 1, wherein said slide presents a body having a general plate-like conformation, with a front vertical face and a back vertical face, and in that said support structure defines a guide vertical plane of the slide, to which said back face of the slide is opposite, and in that said anti-fall device is situated amongst opposite surfaces of said guide plane and said back face of the slide.

3. Unit according to claim 1, wherein said anti-fall device includes a vertical rack and an engagement element of the rack, respectively carried by said support structure and said back face of the slide, or vice versa by said back face and said support structure.

4. Unit according to claim 2, wherein the guide plane defined by said support structure has a width corresponding with the width of said slide and in that said anti-fall device is arranged along opposite side portions of said guide plane and the back face of the slide.

5. Unit according to claim 4, wherein the rack is carried by said guide plane and the engagement element is carried by said slide.

6. Unit according to claim 5, wherein said guide plane of the slide includes a central portion, carrying drive means engaged by the slide and a side vertical portion, protruding with respect to the main portion of the guide plane, on which the rack is arranged.

7. Unit according to claim 6, wherein said back face of the slide includes a central portion, carrying engagement means of the aforesaid drive means, and a side vertical portion, protruding with respect to the main portion of the back face of the slide, on which said engagement element is foreseen.

8. Unit according to claim 7, wherein said opposite side portions of the back face of the slide and the guide plane defined by the support structure are substantially situated in a same plane parallel to the guide plane of the slide and substantially passing through an axis of said drive means of the slide movement.

9. Unit according to claim 3, wherein the engagement element is slidably mounted between an advanced engagement position of the rack and a down retracted position.

10. Unit according to claim 9, wherein to the engagement element springy means are associated, for pushing the engagement element towards its advanced position.

11. Unit according to claim 10, wherein actuator means for maintaining the engagement element in its retracted position, against the action of the aforesaid springy means, are foreseen.

12. Unit according to claim 11, wherein a sensor device, suitable for detecting the position of the engagement element and signaling it to electronic control means for allowing the machine operation only when the engagement element is in its retracted position, is foreseen.
